(19) United States
(12) Patent Application Publication
(10) Pub. No.: US 2006/0255070 A1
(43) Pub. Date: Nov. 16, 2006

(54) Food-extruding apparatus

(76) Inventor: Chin-Ta Chiang, Taichung County (TW)

Correspondence Address: BIRCH STEWART KOLASCH & BIRCH, PO BOX 747, FALLS CHURCH, VA, 22040-0747, US

(21) Appl. No.: 11/126,316

(22) Filed: May 11, 2005

(51) Int. Cl. G01F 13/00

(52) U.S. Cl. 222/252

(57) ABSTRACT

The present invention discloses a food-extruding apparatus, which comprises a table. A charging hopper is installed on the top of the table and has an upward opening. The external side of the bottom of the charging hopper has a propeller pump, which can propel the food material in the bottom of the charging hopper. The improvement of the present invention is that a feeding screw is installed inside the charging hopper and obliquely with respect to the axis of the charging hopper. The food material inside the charging hopper can be gradually guided downward via the rotation of the feeding screw; in cooperation with the propeller pump, the food material is then further propelled toward the succeeding processing procedure. The obliquely-installed feeding screw also enables the food material to be conveniently poured into the charging hopper.

### FIELD OF THE INVENTION

The present invention relates to a food-processing apparatus, particularly to a food-extruding apparatus, which can transport food material to the next processing procedure.

### BACKGROUND OF THE INVENTION

Generally speaking, the conventional food-extruding apparatus comprises primarily a vertical charging hopper and a horizontal pump, wherein a vertical feeding screw is installed inside the charging hopper. When food material, such as dough, is poured into the charging hopper and the feeding screw is switched on, the food material will be pushed to the bottom of the charging hopper, and then the sucking force of the horizontal pump will send the food material to the next processing procedure. However, as the contained angle between the transportation direction of the food material and the sucking direction of the pump is 90 degrees, the sucking force of the pump not only cannot completely apply to the food material inside the charging hopper but also will be degraded obviously. Therefore, the conventional food-extruding apparatus cannot effectively pump the food material inside the charging hopper to the next processing procedure.

### SUMMARY OF THE INVENTION

The primary objective of the present invention is to provide a food-extruding apparatus, which comprises an upright table; the top of the table has a charging hopper with an upward opening; the external side of the bottom of the charging hopper has a propeller pump, which can pump food material in the bottom of the charging hopper. The improvement of the present invention is that a feeding screw is installed inside the charging hopper and obliquely with respect to the central axis of the charging hopper to enable the food material inside the charging hopper to be gradually guided downward via the rotation of the feeding screw and to be fully propelled toward the next processing procedure in cooperation with the propeller pump so that the objectives of conveniently pouring food material into the charging hopper and pumping food material fully toward the next processing procedure can be achieved.

### BRIEF DESCRIPTION OF THE DRAWINGS

FIG. 1 is a front view according to a preferred embodiment of the present invention.

FIG. 2 is a side view according to a preferred embodiment of the present invention.

FIG. 3 is a schematic diagram according to another preferred embodiment of the present invention.

### DETAILED DESCRIPTION OF THE PREFERRED EMBODIMENTS

To enable the objectives, characteristics, and accomplishments of the present invention to be easily understood, preferred embodiments are to be described below in detail in cooperation with the attached drawings.

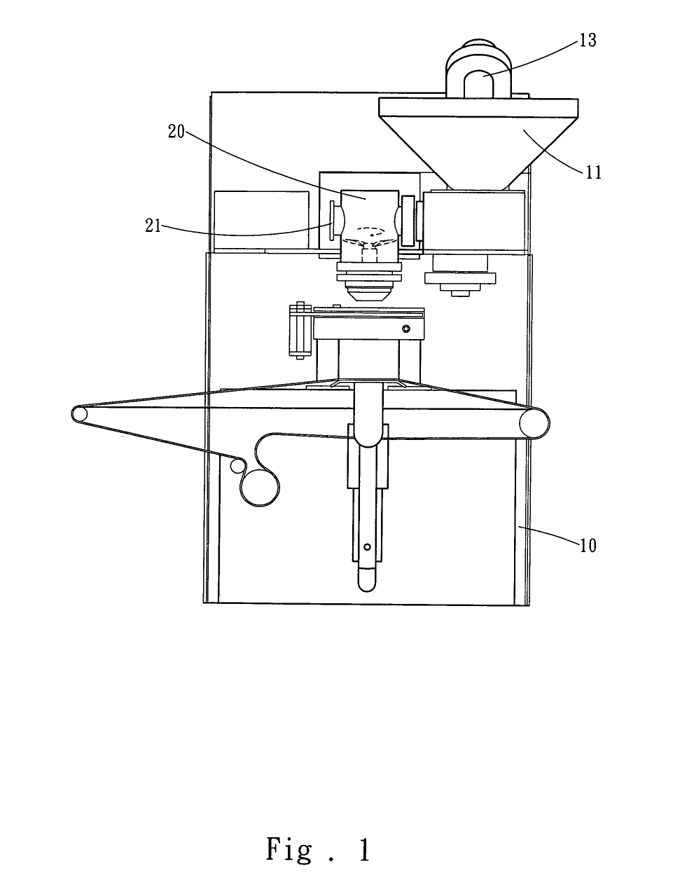

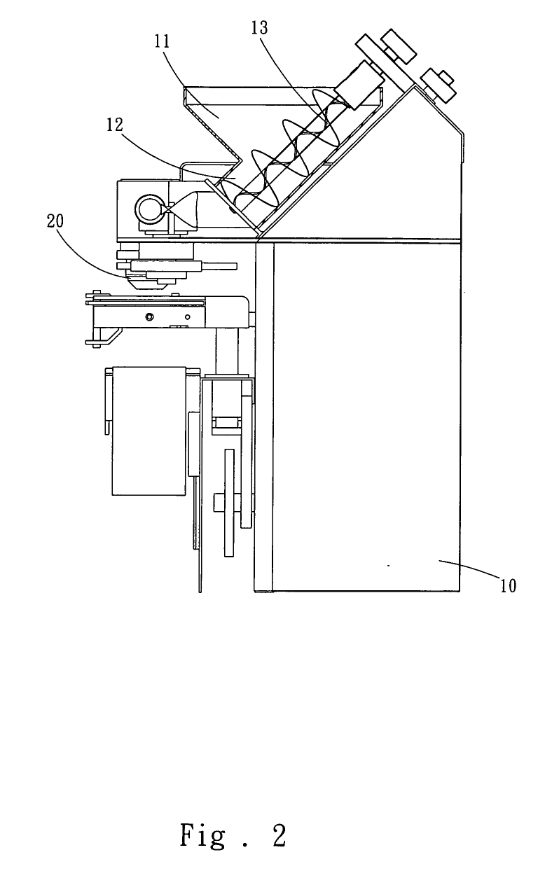

Referring to FIG. 1 and FIG. 2, the food-extruding apparatus of the present invention has an upright table 10; a charging hopper 11 is installed on the top of the table 10 and has an upward opening with a trumpet-like shape for feeding food material and has a guidance exit 12 smaller than the opening and oblique with respect to the charging hopper 11; a propeller pump 20 is installed on the external side of the bottom of the charging hopper, and the propeller of the propeller pump 20 rotates horizontally to propel food material in the bottom of the charging hopper 11 toward an exit 21 of the table 10. The improvement of the present invention is that a feeding screw 13, which is installed inside the charging hopper 11 and obliquely with respect to the axis of the charging hopper 11 and has one end extending into the guidance exit 12 of the charging hopper 11 and parallels the guidance exit 12, to enable the food material inside the charging hopper 11 to be gradually guided downward toward the guidance exit 12 in the bottom of the charging hopper 10 via the rotation of the feeding screw 13 and to be fully propelled toward the exit 21 of the table 10 in cooperation with the propelling force from the horizontally-rotating propeller of the propeller pump 20 for the succeeding processing procedure.

In the present invention, as the feeding screw 13 is disposed onto the side of the charging hopper 11, and installed obliquely inside the charging hopper 11, the charged food material will not be retarded by the feeding screw 13, and thus, the charging hopper 11 has a larger space for food material charge. Further, as the lower end of the feeding screw 13 is parallel to the guidance exit 12 of the charging hopper 11, the food material can be effecfively guided downward, and in cooperation with the propelling force from the horizontally-rotating propeller of the propeller pump 20, the food material inside the charging hopper 11 can be rapidly propelled toward the next processing procedure. Therefore, the present invention can overcome the drawback of the prior art that the pumping force cannot be fully exploited owing to the perpendicular between the feeding screw and the pump.

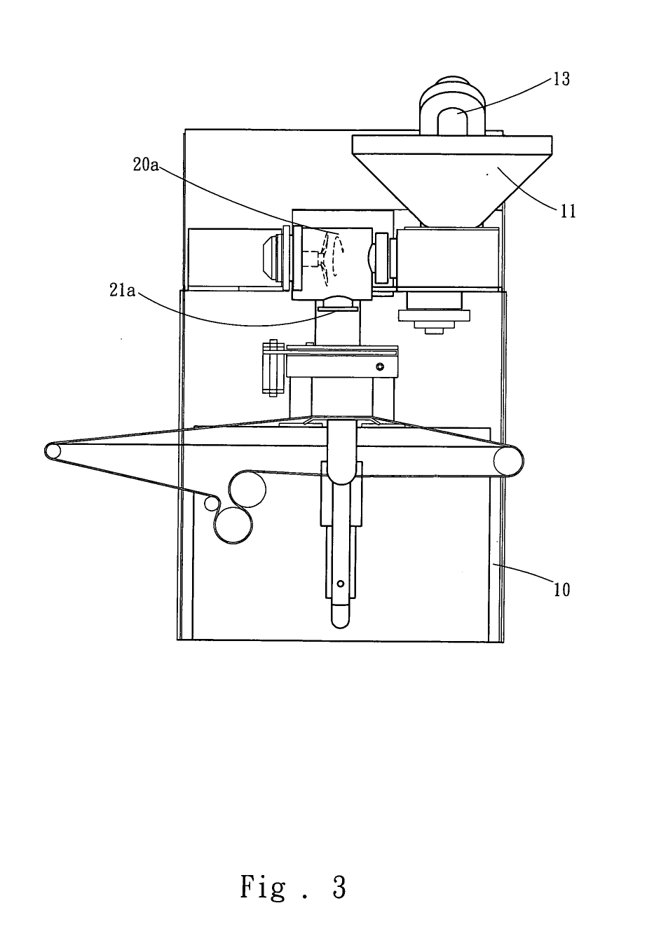

According to a second embodiment of the present invention, a vertically-rotating propeller pump 20a is adopted, as shown in FIG. 3. Via the feeding screw 13 disposed onto one side of the charging hopper 11 and installed obliquely, the food material is obliquely pushed downward, and the propelling force of the propeller pump 20a installed on the lateral side of the bottom of the charging hopper 11 can further propel the food material toward a vertical exit 21a of the table 10 for the succeeding processing procedure.

Those described above are only the preferred embodiments of the present invention but not intended to limit the scope of the present invention. Any equivalent modification and variation according to the claims of the present invention is to be included within the scope of the present invention.

What is claimed is:

1. A food-extruding apparatus, comprising a table, wherein a charging hopper with an upward opening is installed on the top of said table; a guidance exit smaller than said opening is installed on the bottom of said charging hopper; a propeller pump, which can apply a propelling force to the food material in the bottom of said charging hopper, is also installed on the bottom of said charging hopper; a feeding screw installed obliquely with respect to the axis of said charging hopper; the rotation of said feeding screw can enable the food material inside said charging hopper to be guided downward; and the propelling force of said propeller pump can further fully propel the food material toward the next processing procedure.

2. The food-extruding apparatus according to claim 1, wherein said guidance exit on the bottom of said charging hopper is designed to be oblique with respect to the axis of said charging hopper to enable the bottom end of said feeding screw to be parallel thrust into said guidance exit.

3. The food-extruding apparatus according to claim 1, wherein said propeller pump is also installed on a lateral side of the bottom of said charging hopper and utilizes propelling force of a horizontally-rotating propeller to propel the food material in the bottom of said charging hopper.

4. The food-extruding apparatus according to claim 1, wherein said propeller pump utilizes propelling force of a vertically-rotating propeller to propel the food material in the bottom of said charging hopper.
